(19) United States
(12) Patent Application Publication
(10) Pub. No.: US 2012/0240959 A1
(43) Pub. Date: Sep. 27, 2012

(54) Carwash Emergency Stop

(76) Inventor: Robert J. Harter, La Crosse, WI (US)

(21) Appl. No.: 13/492,836

(22) Filed: Jun. 9, 2012

(51) Int. Cl. B08B 7/04; B08B 3/02

(52) U.S. Cl. 134/18; 134/56 R

(57) ABSTRACT

A carwash includes an emergency stop triggered by a car horn. A controller with a microphone listens to various sounds generated during the carwash process and performs a simple spectrum analyses to identify sounds characteristic of car horns. Rather than knowing beforehand a plethora of different car horns, the controller recognizes any number of unknown car horns because virtually all car horn tones are each comprised of multiple prominent frequencies, as opposed to a single frequency note such as the electronic “beeeeep” of a microwave oven. Steady, multiple prominent frequency tones of car horns are readily distinguishable from the noise of carwash spray, which might explain why humans can readily distinguish a car horn from carwash noises, regardless of whether the horn is louder or quieter than the surrounding carwash sounds. In some examples, the horn-activated emergency stop automatically sends a text/video message to a remote carwash owner or manager.

### FIELD OF THE DISCLOSURE

The subject invention generally pertains to carwashes and more specifically to means for improving their safety and minimizing their liability to carwash owners and operators.

### BACKGROUND

Carwashes for automatically washing cars, trucks, trailers and other vehicles typically comprise a carwash apparatus with one or more sprayers for spraying water, soap, wax and various chemical treatments on the vehicle. The sprayer might be part of a spray wand dedicated for spraying, or the sprayer might be incorporated with brushes or other cleaning equipment. Carwash apparatuses are usually powered and controlled to provide relative movement between the sprayer and the vehicle. The sprayer, for example, might travel along the vehicle's outer perimeter, or the vehicle might travel while the sprayer is stationary, or both the sprayer and the vehicle move.

Carwashes typically generate a broad range of spray noise including various other carwash sounds. Liquid sprayed against various parts of the vehicle generates noise, and the liquid exiting a spray nozzle itself generates noise. In addition, the operation of motors, pumps and trolleys also generate various sounds.

### BRIEF DESCRIPTION OF THE DRAWINGS

FIG. 1 is a cross-sectional side view of an example carwash system prior to actuation of an emergency stop.

FIG. 2 is a cross-sectional side view similar to FIG. 1 but showing a car horn having triggered an emergency stop.

FIG. 3 is a cross-sectional side view similar to FIGS. 1 and 2 but showing the carwash after the emergency stop.

FIG. 4 is a graph of an audio signal generated by a combination of a horn sound and a spray noise.

FIG. 5 is a graph of the audio signal in a magnitude versus frequency domain.

FIG. 6 is a graph similar to FIG. 5 but after applying an averaging function to the signal.

FIG. 7 is a block diagram illustrating various example methods associated with the carwash system.

### DETAILED DESCRIPTION

Various unexpected emergencies can happen at a carwash. Examples of such emergencies include, but are not limited to, a sprayer striking or scraping against the car, a window of the car being stuck open, a child suddenly opening a car door or window and exposing the child to high pressure spray, the customer suddenly recalling that cargo is on the vehicle's exterior, the customer realizing the vehicle's side mirrors or antenna are not retracted, the customer noticing that the vehicle's gas cap is missing, the sprayer failing to ever stop, etc.

To improve carwash safety; to avoid various carwash incidents such as personal injury, damage to a vehicle and damage to the carwash itself, and to provide a carwash owner or manager with the convenience of remote access to the carwash, an example carwash system 10 provides its patrons with an emergency stop actuated by the user simply honking a car horn 12. In some examples, horn 12 triggers an emergency stop, and a text and/or video message notifies the carwash owner of the event. The carwash owner, in some examples, can send a text message reply that selectively affirms the emergency stop condition or resets the carwash to normal operation.

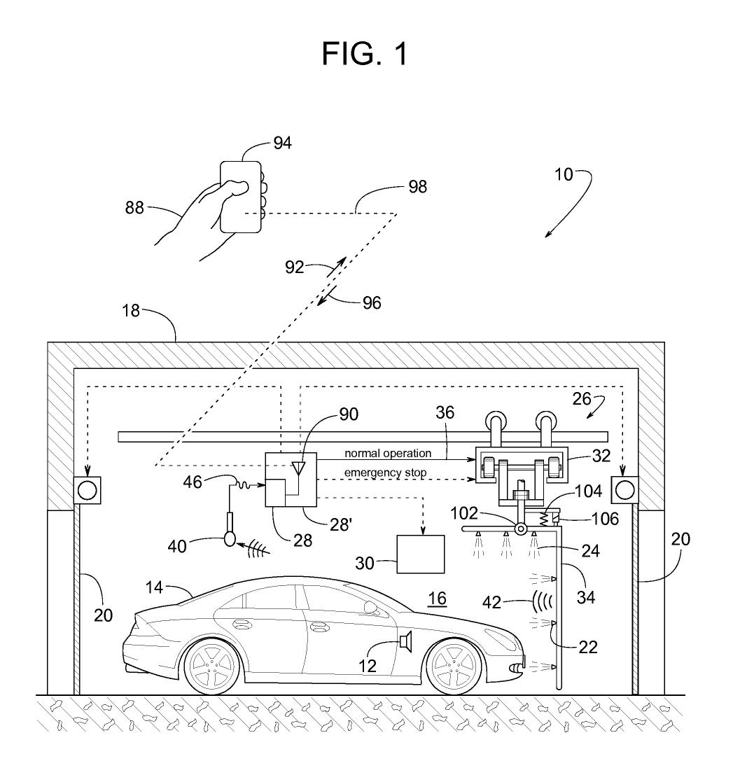

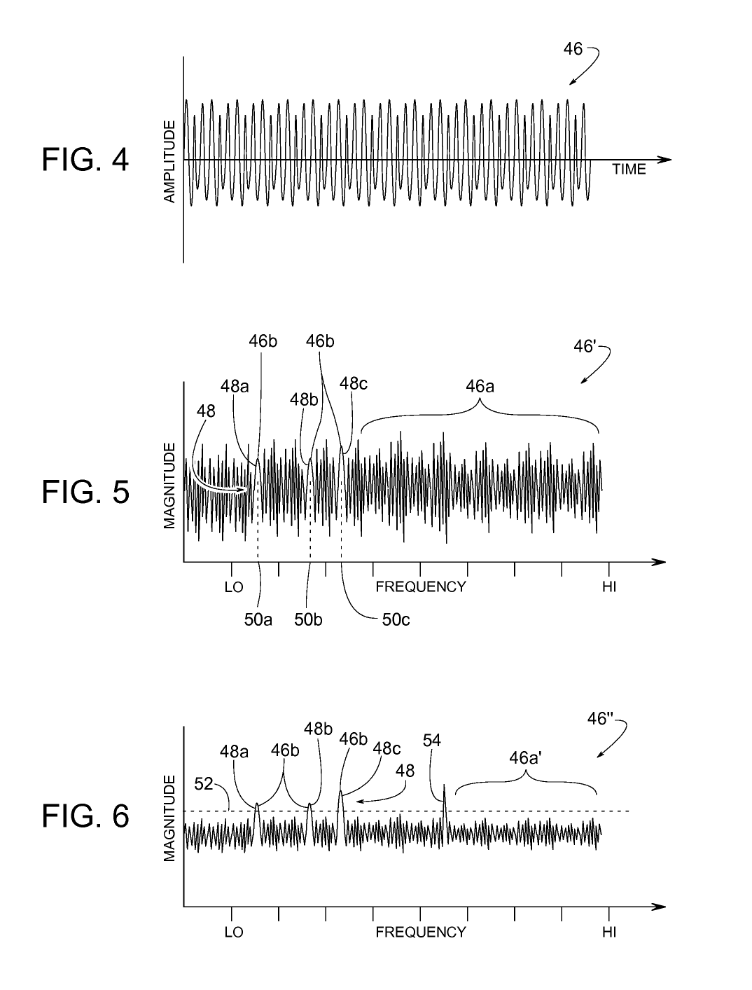

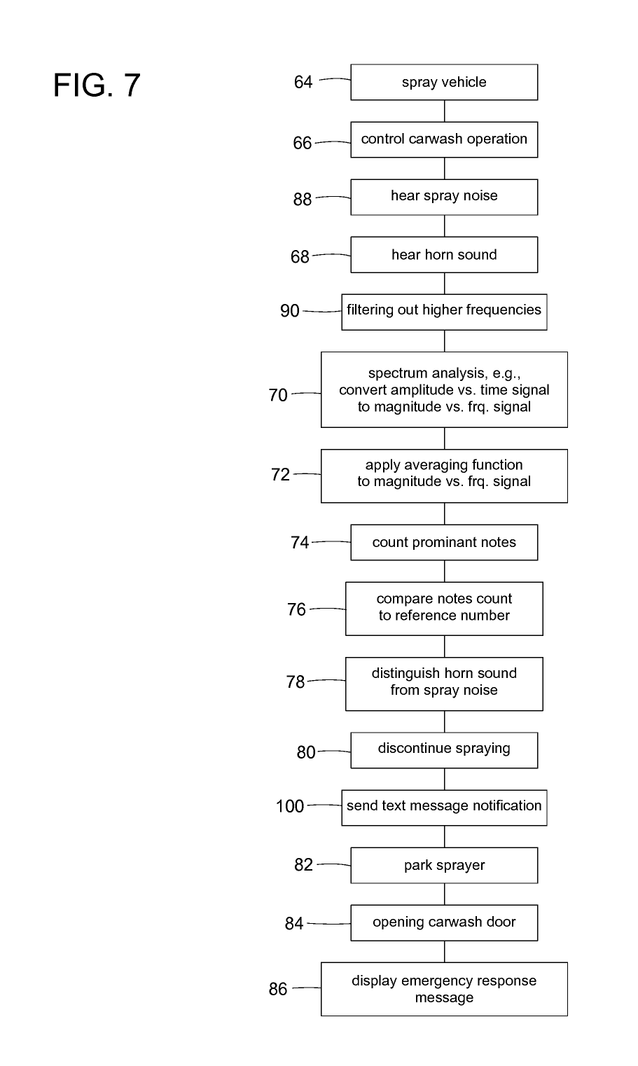

FIGS. 1-7 illustrate example carwash system 10 and method that uses horn 12 of a vehicle 14 to actuate an emergency stop. FIGS. 1-3 show vehicle 14 in a carwash bay 16, FIGS. 4-6 illustrate various raw and processed sound signals, and FIG. 7 shows various method steps of system 10. The term, “carwash bay” means any area designated for washing vehicle 14. The term, “vehicle” means any apparatus with wheels for traveling. Examples of vehicle 14 include, but are not limited to, a car, truck, bus, van, trailer, etc. The terms, “horn” and “car horn,” mean any audible alert of a vehicle, thus a car horn can actually be for a truck.

In some examples, system 10 comprises a structure 18 (e.g., building and/or framework) defining carwash bay 16, one or more carwash doors 20 (e.g., rollup door, segmented garage door, etc.) for entering or leaving bay 16, a sprayer 22 for emitting a spray 24 (e.g., spraying water, foam, steam, soap, wax, etc.), a carwash apparatus 26 within bay 16, and a controller 28 for controlling at least some operations of carwash apparatus 26. In some examples, controller 28 also controls some aspects of additional items, such as door 20 and/or a message sign 30. Carwash apparatus 26 is schematically illustrated to represent any apparatus for driving relative movement between vehicle 14 and sprayer 22.

One example of carwash apparatus 26 includes, but is not limited to, a gantry or bridge supported trolley 32 horizontally movable within bay 16, wherein trolley 32 carries a spray wand 34 that in some examples is rotatable about a vertical axis relative to trolley 32. In such an example, controller 28 commands carwash apparatus 26 to move spray wand 34 and its one or more sprayers 22 along the outer perimeter of vehicle 14. In other examples, carwash apparatus 26 includes a conveyor that moves vehicle 14 through bay 16 such that vehicle 14 is sprayed as it travels past sprayer 22, wherein sprayer 22 is also part of carwash apparatus 26. In the various examples, the movement of carwash apparatus 26 is powered by any suitable means, e.g., powered by one or more conventional motors, hydraulic cylinders, chains, cogged belt, sheaves, sprockets, and various combinations thereof, etc.

The operation of carwash apparatus 26 is controlled by controller 28 alone or, in some examples, in combination with a main controller 28′. For instance, in some examples, main controller 28′ controls the positioning of trolley 26 and sprayer 22 while controller 28 determines whether carwash apparatus 26 functions in a normal operating mode or an emergency shut-down mode. In some examples, controller 28 and main controller 28′ are individual items wired or wireless connected in communication with each other. In some examples, controller 28 is a retrofit added to an already existing main controller 28′. In some examples, controllers 28 and 28′ are incorporated as a single unit. Examples of controller 28, main controller 28′, and a combination of controllers 28 and 28′ include, but are not limited to, a computer, a microprocessor, an electrical circuit, one or more motor drive units, a programmable logic controller, and various combinations thereof.

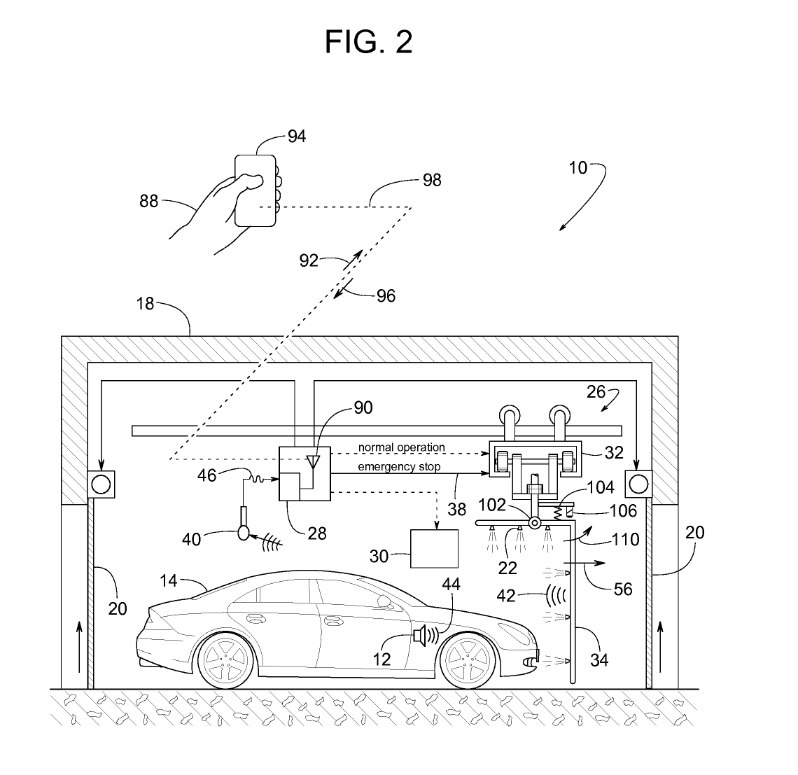

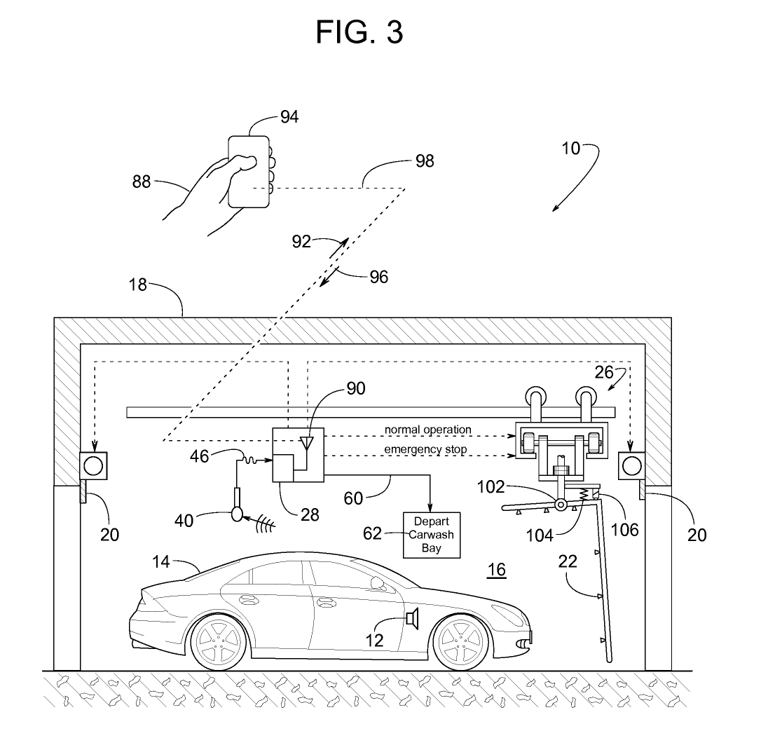

Controller 28, in some examples, provides various output signals to control the operation and positioning of carwash apparatus 26. FIG. 1 shows controller 28 during a first period providing a normal operating signal 36 that controls carwash apparatus 26 in a conventional, non-emergency manner, e.g., a normal cleaning mode. FIG. 2 shows controller 28 during a second period providing an emergency shut-down signal 38 that commands carwash apparatus 26 to shut down (emergency mode). FIG. 3 shows carwash apparatus 26 after being shut down. Controller 28 automatically shifts carwash apparatus 26 from the cleaning mode to the emergency mode in response to a horn-triggered emergency stop.

To provide system 10 with a horn-triggered emergency stop, controller 28 is connected in communication with a microphone 40 that listens to the surrounding sound, such as a spray noise 42 from sprayer 22, a horn sound 44 from horn 12, and various other sounds from carwash apparatus 26. In some examples, microphone 40 is an integral part of controller 28. In some examples, microphone 40 is installed within bay 16 at a location remote to the remaining portion of controller 28 but still wired or wirelessly connected to it.

Since a human can readily distinguish a car horn from carwash noises and do so regardless of whether the car horn is louder or quieter than the carwash noises and regardless of which tone a particular car horn emits, it would seem possible that a computerized sound analyzer could recognize a horn as well, particularly since computers have been programmed to recognize speech comprised of many subtly different sounds and tones. Examples of voice recognition software include, but are not limited to, Dragon Naturally Speaking, CMU Sphinx, Julius, simon, iATROS, RWTH ASR, SHoUT, and VoxForge. In some examples, controller 28 employs some elements of speech recognition software to distinguish horn sound 42 from ambient spray noise 42 (including other carwash sounds). In some examples, as illustrated in FIGS. 4-6, controller 28 receives and processes an audio signal 46 comprising a spray component 46a reflective of spray noise 42 and a horn component 46b reflective of horn sound 44.

Specifically, FIG. 4 shows audio signal 46 as an amplitude versus time domain signal. The term, “signal” means any physical indicator (e.g., voltage, current, etc.) or numerical indicator (e.g., data, binary, function, etc.). In such a representation, as shown in FIG. 4, it can be difficult although not impossible to distinguish horn sound 44 from spray noise 42. Thus, controller 28 performs a spectrum analysis (e.g., Fourier transform and/or other known means) to convert the audio signal's amplitude versus time domain signal of FIG. 4 to a magnitude versus frequency domain signal 46′ shown in FIG. 5. One example of spectrum analysis software includes, but is not limited to, “Visual Analyzer” of www.sillanumsoft.org. In the magnitude versus frequency domain signal 46′ of FIG. 5, horn component 46b appears as being comprised of a plurality of prominent notes 48 (e.g., notes 48a, 48b and 48c) distributed over a plurality of discrete, steady, spaced-apart frequencies 50a, 50b and 50c, respectively. Such multiple discrete notes 48 provide a tone characteristic of conventional car horns. In some examples, notes 48 each being at a substantially constant frequency, makes notes 48 prominent in that they do not fluctuate in frequency nearly as much as spray noise 42 (spray component 46a), which is very erratic. In some examples, notes 48 are prominent in that they are of volume that fluctuates less than other sounds in wash bay 16. In some examples, notes are prominent in that they are of greater volume than other sounds within bay 16 (as sensed by microphone 40).

To see notes 48 more clearly and thus make it easier to distinguish horn sound 42 from spray noise 42, controller 28 applies an averaging function to the magnitude versus frequency domain signal 46′ of FIG. 5 to create the average magnitude versus frequency domain signal 46″ shown in FIG. 6. While FIG. 5 shows a snapshot taken generally at an instant of time, FIG. 6 shows an average of several such snapshots taken over a short span of time. In some examples, FIG. 6 represents the average of three separate snapshots spanning a period of one second. Since spray noise 42 (spray component 46a) is erratic, changing in magnitude and frequency, its average value 46a′ is smoothened out or flatter. Horn sound 44, however, is comprised of notes 48 that are substantially constant in magnitude and frequency, thus the average of each note 48 sampled repeatedly over a span of time is substantially the same as a snapshot at a single instant of time. As a result, FIG. 6 shows the magnitude of notes 48 being the same as their magnitude in FIG. 5, while the average magnitude of noise is 46a′ is considerably smaller than signal 46a. This makes it easy to see and distinguish horn component 46b from spray component 46a′.

Although spray noise 42 can be quite erratic, other sounds of carwash apparatus 26 might be at a more constant magnitude and frequency. A water pump, for instance, might emit a constant hum or whirr. Nonetheless, there are various ways to prevent such a non-horn sound from being interpreted as a car horn. In some examples, with reference to FIG. 6, controller 28 counts the prominent notes or spikes exceeding a predetermined magnitude 52 and compares the count to a predetermined number. For the illustrated example, a spike 54 represents the whirr of a motor driven pump. So, in this example, the count would only be one for spike 54 if no horn is sounded. If horn 12 is sounded, notes 48a, 48b and 48c would be added to spike 54 for a total count of four. If the predetermined reference number is chosen to be three, then a single spike 54 without horn 12 would result in a count of one, which is less than three, so controller 28 would determine that no horn sound is triggering an emergency stop. If, however, horn 12 is sounded, then notes 48 plus spike 54 would provide a total count of four, which is greater than the predetermined number of three, so controller 28 would determine that horn 12 has been activated to initiate an emergency stop.

In some examples, the predetermined number is chosen to be one or two greater than the number of spikes 54 expected during normal car washing. In some examples, the predetermined number varies over time depending on the wash cycle. For instance, in some examples, the predetermined number is lower during the initial presoak period of the wash cycle, and the predetermined number is higher as additional pumps are activated later in the cycle.

In addition or alternatively, other means are employed to help distinguish horn sound 44 from spray noise 42, wherein the term, “spray noise” broadly encompasses all non-horn sounds sensed by microphone 40. Examples of spray noise 42 include, but are not limited to, liquid discharging from sprayer 22, liquid spray striking vehicle 14, engine noise from vehicle 14, and motor and pump noises of carwash apparatus 26, etc. To prevent such non-horn sounds from triggering a false emergency stop, in some examples, microphone 40 is a directional microphone focused on the area where horn 12 is most likely to be located. In some examples, controller 28 filters out higher frequency noise, e.g., filters out sounds above 7,000 hertz. In some examples, to avoid loud stereos from triggering a false alarm, controller 28 only responds to continuous horn sounds that last longer than a predetermined duration, e.g., the horn sounds longer than three continuous seconds. In some examples, controller 28 disregards sounds of less than a predetermined threshold volume to prevent distant horns beyond carwash bay 16 from falsely triggering an emergency stop. In examples where there are multiple bays 16, each carwash bay has its own microphone and the volume of the sounds they sense are compared so that if multiple microphones hear a horn, the controller having the microphone that hears it the loudest responds while the controllers of the other microphones hearing it the least disregard it.

In some examples, a horn-triggered shut-down or emergency stop simply results in de-energizing carwash apparatus 26. In some examples, carwash apparatus 26 first moves to a home or parked position before being de-energized. Arrow 56 of FIG. 2, for example, represents spray wand 34 of apparatus 26 moving from a cleaning position (FIG. 1) to an example parked position (FIG. 3). Such movement or a similar movement 110, in some examples, is spring powered or otherwise non-electrically powered to ensure at least some safe clearance between vehicle 14 and spray wand 34 without having to rely on continued electrical power control. For instance, in some examples, a spring 104 connected to a spray wand knuckle 102 automatically pivots spray wand 34 about knuckle to a retracted or parked position in response to an emergency stop. In some examples, a solenoid 106 when energized resists spring 104 from pivoting spray wand 34 about knuckle 102. When de-energized, however, solenoid 106 releases spring 104 to allow spring 104 to pivot spray wand 34 away from vehicle 14 to a parked position. The term, “parked position” means a location or an orientation of spray wand 34 where spray wand 34 is spaced apart from vehicle 14.

In some examples, a shut-down further includes outputting signals 58 to open one or more doors 20 leading to wash bay 16. In some examples, a shut-down further includes outputting signal 60 to provide a message 62 in a textual and/or audible format, wherein message 62 relates to the actuation of horn 12 (i.e., message 62 was triggered by horn 12). For example, message 62 might tell the driver of vehicle 14 that an emergency stop has occurred and that the driver may depart and/or notify someone in charge of the carwash. In some examples, message 62 explains how to resume normal carwash operation, for instance, by sounding horn 12 in a particular pattern, e.g., three short beeps. In some examples, vehicle 14 departing bay 16 automatically clears the emergency shut-down mode and resets carwash system 10 for normal washing operation of the next vehicle entering carwash bay 16. In some examples, controller 28 includes a counter that tallies the number of horn-actuated emergency stops.

In some examples, the horn-triggered emergency stop is also communicated to a carwash owner or manager 88 at a location remote relative to carwash bay 16. In some examples, in response to a horn-triggered emergency stop, controller 28 transmits via a wireless communication link 98 and wireless transmitter 90 (antenna, modem, combinations thereof, etc.) a message 92 (e.g., a text message—SMS short message service) to a remote electronic device 94 (e.g., cell phone, smartphone, mobile device, laptop computer, IPad, Android touchpad tablet, etc.) thereby notifying a carwash owner or manager 88 of the emergency stop. In some examples, message 92 includes GPS coordinates of the carwash and/or other information identifying which carwash is experiencing the emergency stop. Examples of message 92 include, but are not limited to, a cell phone text message, an email message, a tweet (Twitter, Inc. of San Francisco, Calif.), video message, etc. In the example of message 92 including a video message, a known video camera is installed in carwash bay 16. In some examples, after an emergency stop, manager 88 resets carwash apparatus 26 remotely by sending a resume-to-normal-operation signal 96 from device 94 to controller 28.

FIG. 7 illustrates various method steps of performing a horn-triggered emergency stop of carwash system 10. Block 64 represents washing vehicle 14 by way of carwash apparatus 10. Block 66 represents controller 28 controlling the operation of carwash apparatus 26. Block 68 represents hearing horn 12 while carwash apparatus 26 is washing vehicle 14, wherein the hearing is performed by microphone 40 connected in communication with controller 28. Block 70 represents controller 28 performing a spectrum analysis of audio signal 46 to convert amplitude versus time domain signal 46 to magnitude versus frequency domain signal 46′. Block 72 represents controller 28 applying an averaging function to magnitude versus frequency domain signal 46′. Block 74 represents controller 28 counting the plurality of prominent notes 48 to acquire a count. Block 76 represents controller 28 comparing the count to a predetermined reference number. Block 78 represents controller 28 distinguishing horn sound 44 from spray noise 42. Block 80 represents discontinuing washing vehicle 14 and stopping sprayer 22 in response to microphone 40 hearing horn 12. Block 82 represents moving sprayer 22 to a parked position. Block 84 represents opening carwash door 20. Block 86 represents providing message 62 indicating a course of action to follow after discontinuing washing vehicle 14 in response to microphone 40 hearing horn 12. Block 100 represents transmitting text message 92 to portable electronic device 94 in response to microphone 40 hearing horn 12. Block 88 represents microphone hearing spray noise 42, and block 90 represents filtering out higher frequencies.

Although certain example methods, apparatus and articles of manufacture have been described herein, the scope of the coverage of this patent is not limited thereto. On the contrary, this patent covers all methods, apparatus and articles of manufacture fairly falling within the scope of the appended claims either literally or under the doctrine of equivalents.

1. A carwash method for a vehicle with a horn, the carwash method comprising:
washing the vehicle by way of a carwash apparatus;
a controller controlling operation of the carwash apparatus;
hearing the horn while the carwash apparatus is washing the vehicle, the hearing being performed by a microphone communicating with the controller; and
discontinuing washing the vehicle in response to the microphone hearing the horn.

2. The carwash method of claim 1, wherein the horn emits a horn sound and the carwash apparatus emits a spray noise, and the carwash method further comprising the controller distinguishing the horn sound from the spray noise.

3. The carwash method of claim 2, further comprising:
the microphone sending an audio signal to the controller, the audio signal includes a spray component reflective of the spray noise and a horn component reflective of the horn sound;
the controller performing a spectrum analysis of the audio signal; and
the controller distinguishing the horn sound from the spray noise based on the spectrum analysis.

4. The carwash method of claim 3, wherein the audio signal is an amplitude versus time domain signal, and the controller performing the spectrum analysis converts the amplitude versus time domain signal to a magnitude versus frequency domain signal.

5. The carwash method of claim 4, further comprising the controller applying an averaging function to the magnitude versus frequency domain signal.

6. The carwash method of claim 4, wherein the magnitude versus frequency domain signal includes a plurality of prominent notes distributed over a plurality of discrete spaced-apart frequencies, the controller counting the plurality of prominent notes to acquire a count, and the controller distinguishing the horn sound from the spray noise by comparing the count to a predetermined reference number.

7. The carwash method of claim 6, wherein the plurality of prominent signals each have an magnitude appreciably greater than all remaining portions of the magnitude versus frequency domain signal.

8. The carwash method of claim 6, wherein the plurality of prominent signals each have a substantially steady frequency.

9. The carwash method of claim 1, wherein discontinuing washing the vehicle in response to the microphone hearing the horn involves stopping a sprayer from spraying.

10. The carwash method of claim 1, wherein discontinuing washing the vehicle in response to the microphone hearing the horn involves moving a sprayer to a parked position.

11. The carwash method of claim 1, wherein discontinuing washing the vehicle in response to the microphone hearing the horn involves opening a carwash door.

12. The carwash method of claim 1, further comprising providing a message indicating a course of action to follow after discontinuing washing the vehicle in response to the microphone hearing the horn, wherein the message relates to the horn.

13. The carwash method of claim 1, further comprising transmitting a message to a portable electronic device in response to the microphone hearing the horn.

14. The carwash method of claim 13, wherein the portable electronic device is a cell phone.

15. A carwash method for a vehicle with a horn, the carwash method, comprising:
washing the vehicle by way of a carwash apparatus;
the horn emitting a horn sound;
the carwash apparatus having a sprayer emitting a spray during a first period;
the carwash apparatus emitting a spray noise;
a controller controlling operation of the carwash apparatus;
hearing the horn while the carwash apparatus is washing the vehicle during the first period, the hearing being performed by a microphone communicating with the controller;
the controller distinguishing the horn sound from the spray noise; and
discontinuing washing the vehicle upon the microphone hearing the car horn and the controller distinguishing the horn sound from the spray noise, wherein discontinuing washing the vehicle upon the microphone hearing the car horn and the controller distinguishing the horn sound from the spray noise involves opening a carwash door and stopping the sprayer from emitting the spray.

16. The carwash method of claim 15, further comprising:
sending an audio signal to the controller, the audio signal includes a spray component reflective of the spray noise and a horn component reflective of the horn sound;
the controller performing a spectrum analysis of the audio signal; and
the controller distinguishing the horn sound from the spray noise based on the spectrum analysis.

17. The carwash method of claim 16, wherein the audio signal is an amplitude versus time domain signal, and the controller performing the spectrum analysis converts the amplitude versus time domain signal to a magnitude versus frequency domain signal.

18. The carwash method of claim 17, wherein the magnitude versus frequency domain signal includes a plurality of prominent notes distributed over a plurality of discrete spaced-apart frequencies, the controller counting the plurality of prominent notes to acquire a count, and the controller distinguishing the horn sound from the spray noise by comparing the count to a predetermined reference number.

19. The carwash method of claim 15, further comprising providing a message indicating a course of action to follow after discontinuing washing the vehicle, wherein the message relates to the horn.

20. A carwash system responsive to a horn sound emitted from a car horn, the carwash system comprising:
a carwash bay;
a carwash apparatus in the carwash bay, the carwash apparatus having a cleaning mode and an emergency mode, the carwash apparatus emitting a spray and a spray noise during the cleaning mode, the carwash apparatus being substantially void of the spray during the emergency mode;
a microphone within sensing range of the horn sound and the spray noise;
an audio signal outputted from the microphone, the audio signal during a first period includes a spray component reflective of the spray noise, the audio signal during a second period includes a horn component reflective of the horn sound, the audio signal during the second period includes both the spray component and the horn component; and
a controller connected to receive the audio signal from the microphone, the controller being further connected in control communication with the carwash apparatus, the controller shifting operation of the carwash apparatus from the cleaning mode to the emergency mode in response to the controller receiving during the second period the audio signal including the spray component and the horn component.
